(19) United States
(12) Patent Application Publication
(10) Pub. No.: US 2026/0171620 A1
(43) Pub. Date: Jun. 18, 2026

(54) ELECTRODES WITH MULTIPLE CURRENT PATHS

(71) Applicant: Ford Global Technologies, LLC, Dearborn, MI (US)

(72) Inventors: Soo Yeon Lim, Canton, MI (US); Jiyun Park, Troy, MI (US); Claudia Jazowski, Ferndale, MI (US); Gang Guo, Saline, MI (US)

(21) Appl. No.: 18/979,264

(22) Filed: Dec. 12, 2024

(51) Int. Cl. H01M 50/533; H01M 10/0562; H01M 10/058; H01M 50/105

(52) U.S. Cl. CPC H01M 50/533; H01M 10/0562; H01M 10/058; H01M 50/105; H01M 2220/20

(57) ABSTRACT

Systems and methods are provided for electrodes having multiple current paths. In one example approach, a battery is provided that comprises: a first electrode layer comprising a first positive tab and a first negative tab; and a second electrode layer comprising a second positive tab and a second negative tab, where the second electrode layer is stacked on top of the first electrode layer, where the second positive tab is misaligned with the first positive tab and the second negative tab is misaligned with the first negative tab.

### TECHNICAL FIELD

The present disclosure relates to solid-state batteries.

### BACKGROUND AND SUMMARY

A solid-state battery (SSB) is a type of battery that uses a solid electrolyte for ionic conductions between the electrodes, instead of liquid or gel polymer electrolytes found in conventional batteries, for example. In some examples, solid-state batteries may use metallic lithium for the anode and oxides or sulfides for the cathode, thereby increasing energy density. The solid electrolyte may act as a separator that allows only lithium ions to pass through. Solid-state batteries may potentially have higher energy density and may function differently than typical lithium-ion or lithium polymer batteries, for example. Solid-state batteries may be used in a variety of devices and machines including, but not limited to, pacemakers, RFID and wearable devices, and electric or hybrid electric vehicles, for example.

In some approaches, SSB electrode cells may be stacked to form a stack of the cells called a pouch cell. A pouch cell may be comprised of multiple layers of positive and negative electrodes with metal electrode tabs located on sides of the cells. During manufacturing, the electrode tabs may be welded to an Al or Ni lead providing a current path from the battery cell to external circuits. Fabrication of some SSB cell configurations may involve a process to laminate layers to form an electrode stack. The laminated electrode stack may be vacuum sealed inside a pouch bag or the like.

Disclosed herein are systems and methods for electrodes, such as electrodes in a solid-state pouch cell battery, having multiple current paths. In one example approach, a battery is provided that comprises: a first electrode layer comprising a first positive tab and a first negative tab; and a second electrode layer comprising a second positive tab and a second negative tab, where the second electrode layer is stacked on top of the first electrode layer, where the second positive tab is misaligned with the first positive tab and the second negative tab is misaligned with the first negative tab.

This and other approaches described herein introduce new electrode designs that incorporate multiple current paths that may distribute the current flow, resulting in a reduction of thermal impacts that may occur during charging and discharging of batteries. The multiple current paths may be achieved by distributing the positions of the tabs, for example. Such approaches may lower an overall heat burden of the battery pack by reducing an accumulation of localized heat, in addition to other advantages described herein.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example electric vehicle with a battery.

FIG. 2 shows a perspective view of an example single layer battery cell.

FIG. 3 shows example current densities and temperature profiles after charging example electrodes.

FIG. 4 shows example current densities after charging example electrodes with different tab positions.

FIG. 5 shows example current densities and temperature profiles after charging example electrodes with different tab positions.

FIG. 6 shows example implementations of multi-current path designs.

FIG. 7 shows additional example implementations of multi-current path designs.

FIG. 8 shows an example method of manufacturing a solid-state pouch cell battery.

### DETAILED DESCRIPTION

As remarked above, solid-state batteries may potentially have higher energy density and may be more consistent than typical lithium-ion or lithium polymer batteries, for example. Solid-state batteries may be used in a variety of devices and machines including, but not limited to, pacemakers, RFID and wearable devices, and electric or hybrid electric vehicles, for example. In electric or hybrid electric vehicles, long-lasting solid-state battery packs, e.g., pouch cells, may provide high-power, enable fast charging, and meet vehicle driver demands. For example, such battery packs may provide sufficient power to move a vehicle from 0 to 60 miles per hour (mph) in a short period of time. However, these characteristics may pose significant thermal challenges during charging and discharging of the battery, such as localized heat near battery tab areas where the current is localized. Such localized heat generation in the battery may lead to thermal degradation, for example.

The solid-state batteries used in electric vehicles (and other applications) may comprise a plurality of individual battery cells stacked together. The localized heat generation in the vicinity of the battery tabs may occur in each individual battery cell so that the heat accumulates within a stack of the cells. As described above, such stacks of cells may be referred to as a pouch cell. A pouch cell may be comprised of multiple layers of positive and negative electrodes with metal electrode tabs located on sides of the cells, e.g., the tabs may be located on the shorter sides of the cells in some examples. During manufacturing, the electrode tabs may be welded to an Al or Ni lead providing a current path from the battery cell to external circuits.

During charging and discharging, current passes through the leads and the battery tabs; thus, heat generation and corresponding material degradation may be localized to regions surrounding the tabs. The heat may be localized near the tab in each battery cell layer, and each layer can affect each other when in a stacked formation, for example. For example, the heat from one layer may transfer to another layer so that the heat accumulates and further increases the overall temperature of the pouch cell. The generated heat may also affect the stability of the battery materials. Although positive and negative electrode materials may be thermally stable in their pristine state, they may become less stable over charging/discharging cycling due to phase transitions, making the materials more susceptible to thermal degradation. Furthermore, in some examples, the materials comprising the battery may readily react with a surrounding electrolyte, thereby promoting electrolyte consumption and generating reactive gases, resulting in rapid reduction in a battery cell's lifespan, for example. In addition, these localized heat effects may become more significant under harsh conditions such as high-power, fast-charging, or longer cycle life conditions.

Thus, new electrode designs incorporating multiple current paths to distribute the current flow are described herein. The approaches described herein may result in a reduction or mitigation of thermal effects. As described in more detail below, multiple current paths may be achieved by distributing the positions of the tabs in battery cell stacks. Such approaches may lower the overall heat burden of a battery pack by reducing an accumulation of localized heat, for example.

It is to be understood that the specific assemblies and systems illustrated in the attached drawings, and described in the specification are example embodiments of the inventive concepts defined herein. For purposes of discussion, the drawings may be described collectively. Thus, like elements may be commonly referred to herein with like reference numerals and may not be re-introduced.

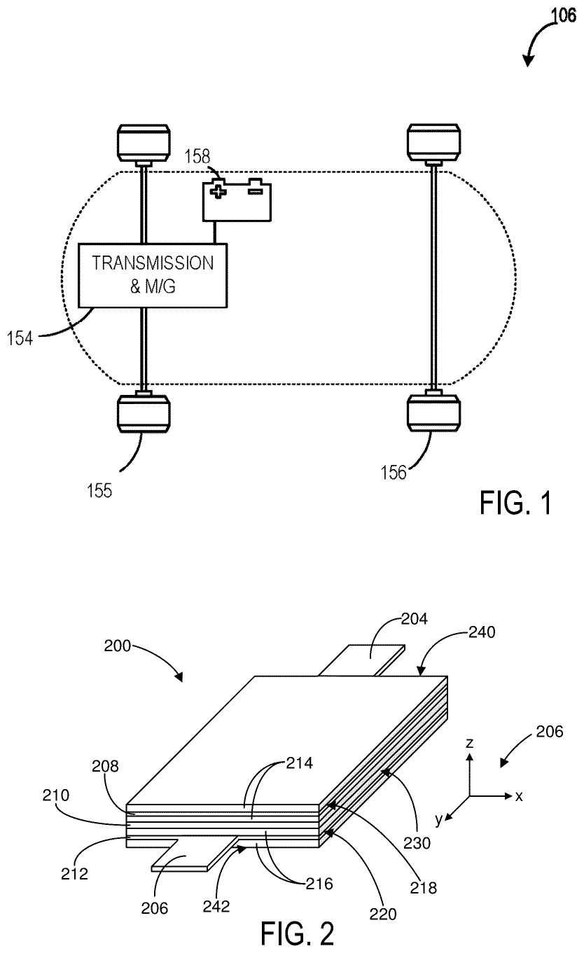

Turning now to the figures, FIG. 1 shows a schematic depiction of an example vehicle system 106 that can derive propulsion power from an electric motor 154 (e.g., a drive motor). As used herein, the terms “electric vehicle” or “EV” is intended to mean any suitable vehicle that is at least partially configured to be propelled using electric power, e.g., via one or more electric motors incorporated in the vehicle. For example, vehicle system 106 may be considered to be an electric vehicle (EV). Though FIG. 1 shows a single electric motor 154, it should be understood that vehicle system 106 may include any suitable number of electric motors to propel the vehicle and/or provide power to various components and systems within system 106. In some examples, electric motor 154 may be a traction motor, however other types of electric motors are contemplated. Electric motor 154 may receive electrical power from a battery 158 to provide torque to rear vehicle wheels 155. Electric motor 154 may also be operated as a generator to provide electrical power to charge battery 158, for example, during a wheel caliper application operation. In some examples, battery 158 may comprise a solid-state battery (SSB) such as described below.

It should be appreciated that while FIG. 1 depicts an electric motor 154 mounted in a rear wheel drive configuration, other configurations are possible, such as employing electric motor 154 in a front wheel configuration, or in a configuration in which there is an electric motor mounted to both the rear vehicle wheels 155 and front vehicle wheels 156. Further, additional electric motors may be included in system 106.

Electric motor 154 may include a gearbox integrated therein and/or may provide input power, together with other electric motors, to a transmission system. Additionally, or alternatively, the electric motor 154 may be coupled to an outside of a transmission/gearbox housing. The integrated gearbox may include one or more input speed reduction gear sets. Electric motor 154 may also include at least one clutch. Additionally, or alternatively, there may be multiple batteries configured to provide power to different driven wheels, wherein power to the wheels may be predicated based on traction at the wheels, driver demand, and other conditions.

Turning now to FIGS. 2-7, various views of an example battery 200 and battery cell stack (e.g., pouch cells) are shown. An axis system 206 is provided in FIGS. 2-7 for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples.

FIG. 2 shows a perspective view of an example single layer battery cell 200. Battery cell 200 may comprise a solid-state battery and may include a stack (e.g., stack 230 shown in FIG. 2) of various components such as anode and cathode layers, electrode coatings, current collectors, solid-state electrolyte separators, etc. The solid-state battery cell 200 may have any suitable design, e.g., bipolar or monopolar (as shown in FIG. 2). One or more tabs, e.g., a negative tab 204 and a positive tab 206, may be included in battery cell 200. The tabs may be in electrical communication with electrode current collectors in the cell.

The example single-layer battery cell 200 shown in FIG. 2 shows a monopolar cell structure, however it should be understood that any suitable cell structure is contemplated and is included in the scope of this disclosure. For example, the single-layer battery cell may comprise a bipolar cell structure or any other suitable cell structure. The example monopolar stack 230 shown in FIG. 2 comprises an anode layer 218 (negative electrode layer) and a cathode layer 220 (positive electrode layer). The anode layer 218 may be separated from the cathode layer 220 by a solid-state electrolyte separator 210. In this example, the anode layer 218 comprises anode coatings 214 positioned on top and bottom surfaces of an anode current collector 208. In this example, the cathode layer 220 comprises cathode coatings 216 positioned on top and bottom surfaces of a cathode current collector 212. In this example, the electrode layers, e.g., the anode layer and the cathode layer, comprise double-side-coated electrodes.

As remarked above, battery cell 200 may comprise a solid-state battery cell. A solid-state battery is an electrical battery that uses a solid electrolyte for ionic conductions between the electrodes, instead of liquid or gel polymer electrolytes found in conventional batteries. Solid-state batteries may provide higher energy density than the typical lithium-ion or lithium polymer batteries. The cathode layers (i.e., positive electrodes) may be made with the same compounds as a lithium-ion battery (e.g., LFP, NMC, LMO, etc). The anode layers (i.e., negative electrodes) may be made of lithium metal (e.g., pure lithium), in some examples. In some examples, a negative electrode may be formed by coating a negative electrode active material such as a lithium metal, a lithium alloy, carbon, petroleum coke, activate carbon, graphite, silicon, silicon oxide, silicon composite, titanium-based material, or the like, on both surfaces of a negative electrode current collector made of copper, nickel, a copper alloy, other potential conductive materials, or any combination thereof. Also, a positive electrode may be formed by coating a positive electrode active material such as a lithium manganese oxide, a lithium cobalt oxide, a lithium nickel oxide, or the like, on both surfaces of a positive electrode current collector made of aluminum, nickel, other potential conductive materials, or a combination thereof.

The separator 210 may be comprised of a generally ceramic (e.g., oxides, sulfides, phosphates), or a solid polymer, which also functions as the electrolyte. It therefore becomes the medium through which the ions move and also has electric insulating properties and functions as a mechanical separator between the anodes and cathodes. The solid electrolyte may function as a separator that allows only lithium ions to pass through. For that reason, solid-state batteries can potentially address various issues, such as limited voltage, solid-electrolyte interface formation, cycling performance, and strength. The separators may be made of a material generally used in the art. For example, a multi-layer film made of polyethylene, polypropylene, or a combination thereof having a microporous structure, or a polymer film for a gel-type polymer electrolyte or a solid polymer electrolyte such as polyvinylidene fluoride, polyethylene oxide, polyacrylonitrile, or polyvinylidene fluoride hexafluoropropylene copolymer may be used.

As mentioned above, a negative tab 204 and a positive tab 206 may be included in battery cell 200. The tabs may be in electrical communication with corresponding electrode current collectors in the cell. For example, the positive tab 206 may be coupled to the cathode current collector 212 and the negative tab 204 may be coupled to the anode current collector 208. In some examples, the tabs may axially protrude from the electrode layer so that the tabs extend a distance beyond an edge of the electrode layers. For example, as shown in FIG. 2, negative electrode 204 extends a non-zero distance beyond edge 240 of cell 200 and positive electrode 206 extends a non-zero distance beyond edge 242 of cell 200.

In some examples, the positive and negative tabs may extend beyond edges of the electrodes on opposing sides of the electrodes, as illustrated in FIG. 2. However, in other examples, the tabs may extend from the same side or same edge or in some other configuration. In some examples, the tabs may be located on the shorter sides of the cells (as illustrated in FIG. 2); however, in other examples, the tabs may extend from longer sides of the cells or a combination of different sides of the cells. During manufacturing, the electrode tabs may be welded to an Al or Ni (or some other suitable metal) lead providing a current path from the battery cell to external circuits, for example. The positive tab and the negative tab may form a current path, e.g., the positive and negative tabs together may form a single current path where current flows between the two tabs. For example, current may flow from the negative tab to the positive tab.

The various components in stack 230 shown in FIG. 2 may be laminated together to affix all the components together. Lamination is a technique/process of manufacturing a material in multiple layers. A laminate is a layered object or material that may be assembled using heat, pressure, welding, or adhesives. Various coating machines, machine presses and/or calendering equipment may be used to laminate the layers in stack 230.

In some examples, multiple single-layer battery cells, such as cell 200 shown in FIG. 2, may be stacked on top of each other and sealed in a pouch to form a pouch cell. As remarked above, pouch cells may be comprised of multiple layers of positive and negative electrodes with metal electrode tabs located on sides of the cells. For example, a pouch cell may comprise at least two single-layer cells stacked together; however, in other examples, any suitable number of single-layer cells may be stacked to form a pouch cell. For example, a pouch cell may comprise more than one single-layer cell. For example, a pouch cell may comprise two, three, four, five, twenty or any suitable number of single-layer cells stacked together. In some examples, the stacked cells may be laminated together. These cell stacks may be vacuum sealed in a pouch to form a pouch cell, for example. The pouch may comprise a bag or other suitable container that is vacuum sealed around the electrode stack, for example. The pouch may form a container, a pocket or a cavity which houses the electrode assembly including the electrode stack. In some examples, the pouch may comprise a porous plastic tube or sleeve made of any suitable material.

As remarked above, during charging and discharging, heat generation and corresponding material degradation may be localized to regions surrounding the tabs. The heat may be localized near the tab in each battery cell layer, and each layer can affect each other when in a stacked formation. For example, the heat from one layer may transfer to another layer so that the heat accumulates and further increases the overall temperature of the pouch cell. The generated heat may also affect the stability of the battery materials.

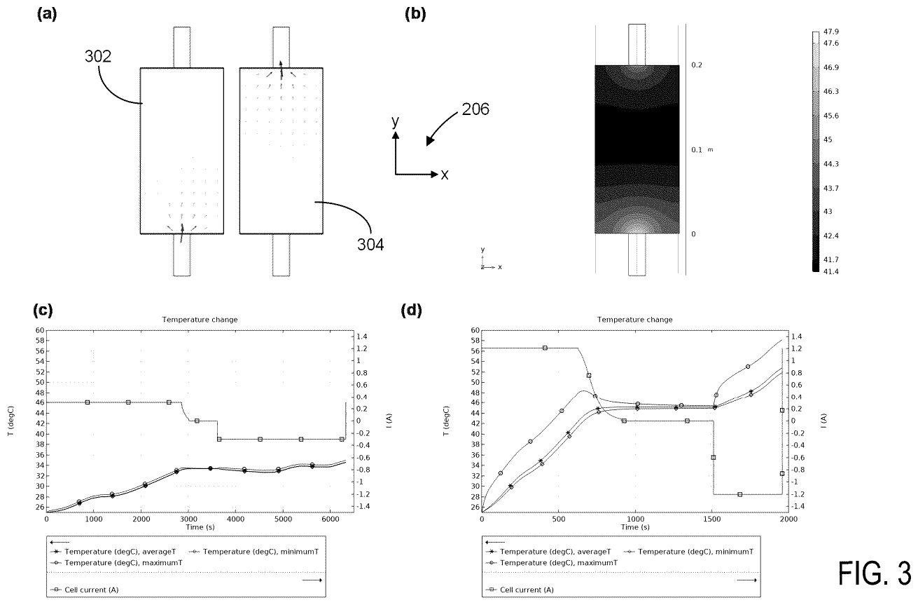

FIG. 3 shows example current densities and temperature profiles after charging example electrodes, such as the single-layer cell 200 shown in FIG. 2. In particular, FIG. 3 (a) shows current density vectors in a cathode current collector 302 and current density vectors in an anode current collector 304. The current vectors shown in FIG. 3 (a) occur at the end of current collector charge at 4C rate, for example. The tab shown on the bottom side is connected to the cathode current collector 302 and the tab on the top side is connected to the anode current collector 304. The arrows shown indicate the direction and magnitude of the current density vectors. In this example, the magnitude of the current density vectors was proportionally scaled by a factor of 2E-9 for visual purposes. FIG. 3 (b) shows temperature distribution across the current collector at the same charging step as in FIG. 3 (a). In FIG. 3 (b) lighter colors indicate higher temperatures. FIG. 3(c) and (d) show example temperature profiles during a constant current-constant voltage (CC-CV) cycle at (c) 1C rate (charging in one hour) and at 4C rate (charging in 15 minutes). The average, maximum, and minimum temperatures in a single cell were evaluated and show that heat generation is localized near the tabs.

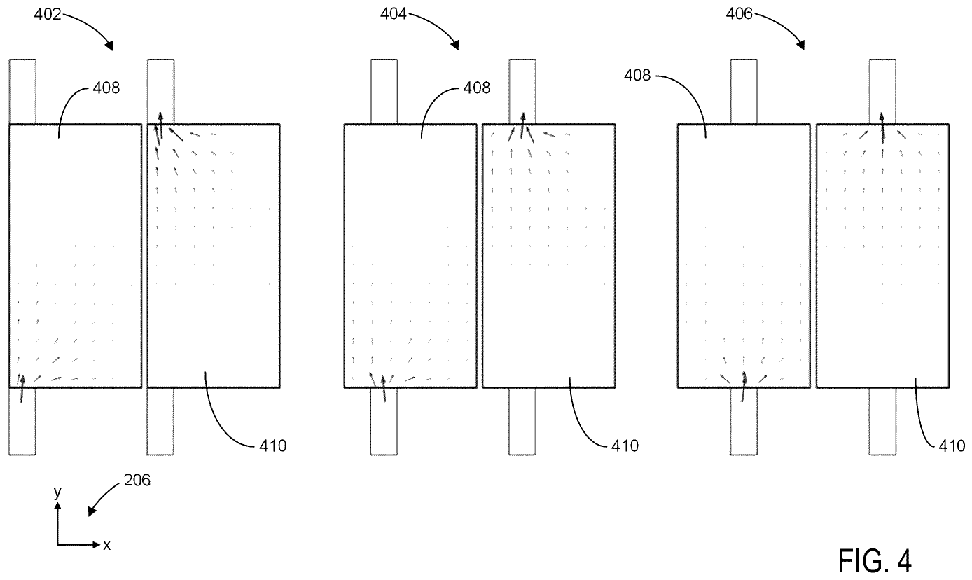

FIG. 4 shows example current densities after charging example electrodes with different tab positions in a battery cell, such as cell 200 shown in FIG. 2. In particular, FIG. 4 shows example current density vectors in a cathode current collector 408 and an anode current collector 410 at the end of a current collector charge at a 4C rate in three different tab positions: a first tab position shown at 402, a second tab position shown at 404, and a third tab position shown at 406. The arrows indicate the direction and magnitude of the current density vectors, and the magnitude of the current density vectors was proportionally scaled by a factor of 2E-9 for visual purposes.

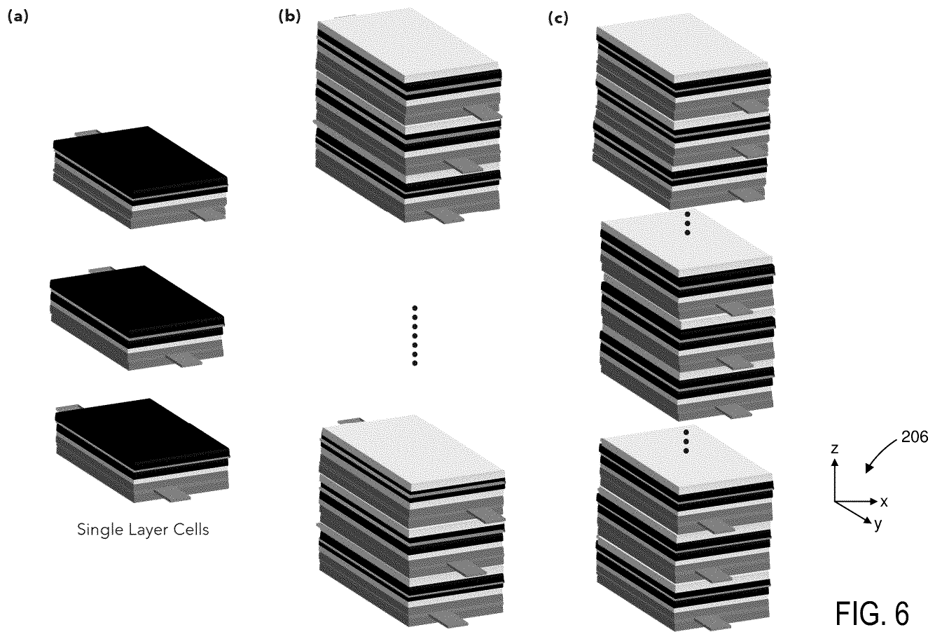

Approaches described herein include designing multi-current paths by diversifying the positions of tabs, such as shown in the different tab configurations at 402, 404, and 406 in FIG. 4. In particular, the tabs may be positioned at different locations along edges of a single-layer battery cell, such as battery cell 200 shown in FIG. 2. The diversified positions shown in FIG. 4 are provided by way of example and various alternate positions of the tabs may be used. In conventional pouch cells, battery cell layers with only one type of tab configuration may be stacked in a pouch cell. For example, all single-layer cells may use the configuration shown at 408 in FIG. 4 and then stacked together so that the tabs are substantially aligned one on top of another in the stack. In such an approach, the localized heat in each layer may accumulate in the same region (e.g., near the aligned tabs) throughout the stack of layers which may lead to an increase of temperature in that region. The position of the localized heat can be distributed by stacking single-layer cells with different tab configurations, e.g., stacking cells with the different configurations shown at 402, 404, and 406 in FIG. 4 (or some other tab configurations that do not overlap or align with each when stacked together). In some examples, single-layer cells having different tab configurations may be alternately stacked in one pouch cell so that the location of heat generation is diversified or spread out at different locations, resulting in reduced temperature impacts on the pouch cell. Examples of such alternate stackings are illustrated in FIG. 6 described below.

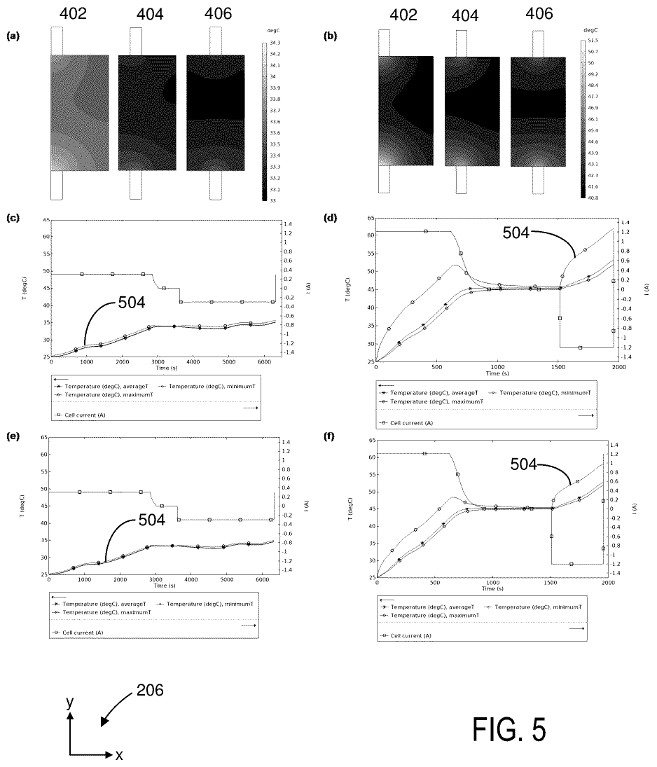

FIG. 5 shows example current densities and temperature profiles after charging example electrodes with different tab positions. In particular, FIG. 5 shows comparisons of the level of the generated heat depending on the different c-rates and the location of tabs. FIG. 5 (a) and (b) show example temperature distributions of the different tab configurations 402, 404, and 406 at the end of current collector charge at 1C rate (a) and 4C rate (b). FIG. 5 (a) and (b) show the overall heat distribution in each design and the maximum heat generated in different positions among three configurations (lighter colors indicate higher temperatures). FIG. 5 (c)-(f) show the temperature profiles of tab configurations 402 and 406 at different c-rates. The maximum temperature is shown in the lines labelled 504 in the graphs and indicates that it changes during cycling and varies depending on the tab configuration. The difference in temperature in different configurations are not significant if the c-rate is constant. In particular, FIG. 5 (c) and (d) show temperature profiles during a CC-CV cycle at 1C rate (c) and 4C rate (d) with the tab configuration 402 where the tabs are on the left side of the battery cell. FIG. 5 (e) and (f) show example temperature profiles during a CC-CV cycle at 1C rate (c) and 4C rate (d) with the tab configuration 406 where the tabs are on the center of the battery cell. At the lower c-rate (1C), the difference in maximum temperature in different configurations is within 3° C. At the higher c-rate (4C), the difference can increase to about 5° C. The average, maximum, and minimum temperatures in a single cell were evaluated and show how the heat may be distributed by positioning the tabs at different locations in the cells in order to reduce the accumulation of the localized heat in a pouch cell.

FIG. 6 shows example implementations of multi-current path designs, where single-layer cells, such a cell 200 shown in FIG. 2, having different tab configurations are stacked such that the different tab configurations are misaligned. In particular, FIG. 6 (a) shows single layer cells with a multi-tab design, where the tabs are located at different positions in different single-layer cells so that when stacked together, e.g., as shown in FIG. 6 (b), the tabs are misaligned or offset from each other in the stack. Two example ways to implement the multi-current path design are illustrated in FIG. 6. For example, FIG. 6 (b) shows alternating stacking of each configuration where different tab configurations are alternately stacked together so that adjacent tabs do not substantially overlap or do not substantially align with each other. FIG. 6 (c) shows another example approach where chunks (e.g., 2 or more single-layer cells) of layers of the same tab configuration are formed and then different chunks with different tab configurations are stacked together so that the tabs in each chunk do not align with (i.e., are misaligned with) the tabs in an adjacent chunk in the stack.

The approaches described herein may be applied in the manufacturing processes in two example ways as depicted in FIG. 6 (however, other stacking approaches may be used that misalign adjacent tabs). In some examples, single-layer cells with multi-tab design may be prepared, and the number of tabs included may vary depending on the size of the cell as shown in FIG. 6 (a). For example, the layers of each configuration may be alternately stacked as shown in FIG. 6 (b). In this approach, the heat may be well distributed throughout the stack; however, it may be susceptible to misalignment. In another approach, each configuration may be stacked together in chunks as shown in FIG. 6 (c). This approach may be advantageous in manufacturing due to its simplicity in stacking and such an approach may reduce possible misalignments.

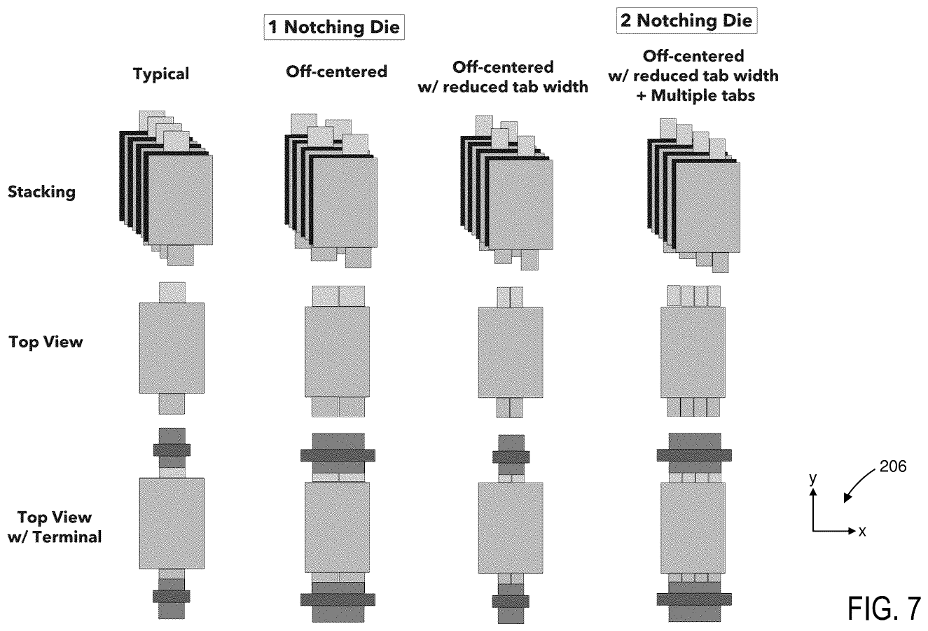

FIG. 7 shows additional example implementations of multi-current path designs. In particular, FIG. 7 shows different example designs that may be manufactured with one notching die and two notching dies with different tab widths. Design strategies may be implemented to further reduce the potential complexity in manufacturing and to increase the compatibility with the existing cell/terminal designs. First, having multiple tab locations implies that multiple notching die designs may be used in the manufacturing process. To minimize the complexity from multiple notching die designs, double-side-coated electrodes may be used, with which two symmetric off-centered electrodes can be produced with only one notching die just by flipping the electrode, for example. FIG. 7 shows one notching die and two notching die examples. With one notching die, two different tab locations may be achieved. With two different notching dies four different tab locations may be utilized. In such approaches, the manufacturing complexity may be reduced. Additionally, such approaches may be compatible with existing electrode-to-cell terminals.

FIGS. 1-7 are drawn approximately to scale, aside from the schematically depicted components. However, the components may have other relative dimensions, in other embodiments. The figures show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Even further, elements which are coaxial or parallel to one another may be referred to as such.

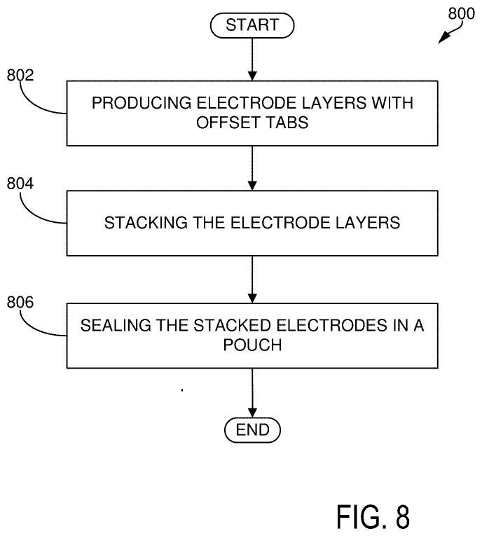

FIG. 8 shows an example method 800 of manufacturing a solid-state pouch cell battery that is formed from a stack of single-layer cells, such as cell 200 shown in FIG. 2, having different tab configurations to distribute heat generated during charging and discharging of batteries. The multiple current paths may be achieved by distributing the positions of the tabs, for example. Such approaches may lower an overall heat burden of the battery pack by reducing an accumulation of localized heat.

At 802, method 800 includes producing electrode layers with offset tabs. For example, multiple different electrode layers or single-layer cells may be produced that have different tab configurations such that, when stacked, are misaligned. For example, producing electrode layers with offset tabs may include producing a first electrode layer comprising a first positive tab extending beyond an edge of the first electrode layer and a first negative tab extending beyond an opposing edge of the first electrode layer; and producing a second electrode layer comprising a second positive tab extending beyond an edge of the second electrode layer and a second negative tab extending beyond an opposing edge of the second electrode layer. In some examples, the first electrode layer and the second electrode layer may each comprise double-side-coated electrodes; and the first and second electrode layers may be produced using a single notching die configuration. In other examples, the first and second electrode layers may be produced using two different notching die configurations. As described above, different notching dies may be used to minimize the complexity from multiple notching die designs. For example, double-side-coated electrodes may be used, with which two symmetric off-centered electrodes can be produced with only one notching die just by flipping the electrode. In some examples, the tabs may be welded into a corresponding current collector in different tab configurations.

At 804, method 800 includes stacking the electrode layers. For example, at 804, method 800 may include stacking the second electrode layer on a top surface of the first electrode layer, where the second electrode is substantially aligned with the first electrode layer; and where the second positive tab is misaligned with the first positive tab and the second negative tab is misaligned with the first negative tab. Arranging electrodes in a stack may comprise positioning a plurality of electrodes, current collectors, solid-state electrolyte layers and the like into a substantially aligned stack, but with adjacent tabs misaligned. For example, the layers of each tab configuration may be alternatively stacked as shown in FIG. 6 (b). In another approach, each configuration may be stacked together in chunks as shown in FIG. 6 (c). The stacked electrode layers may be laminated together in the stack. For example, a suitable lamination process may be performed to affix the electrode and other components, such as solid-state electrolyte separators, current collectors and the like, together in the stack.

At 806, method 800 includes sealing the stacked electrodes in a pouch. For example, the stacked first and second electrode layers may be sealed in a pouch (together with other electrode layers if there are any). These cell stacks may be vacuum sealed in a pouch to form a pouch cell, for example. The pouch may comprise a bag or other suitable container that is vacuum sealed around the electrode stack. The pouch may form a container, a pocket or a cavity which houses the electrode assembly including the electrode stack.

The invention will be further described in the following paragraphs. In one aspect, a battery is provided that comprises: a first electrode layer comprising a first positive tab and a first negative tab; and a second electrode layer comprising a second positive tab and a second negative tab, where the second electrode layer is stacked on top of the first electrode layer, where the second positive tab is misaligned with the first positive tab and the second negative tab is misaligned with the first negative tab. In some examples, the battery may comprise a pouch cell battery. In some examples, the battery may comprise a solid-state battery. In additional examples, the first electrode layer and the second electrode layer may each comprise double-side-coated electrodes. In some examples, the first electrode layer may comprise a first anode, a first anode current collector, a first cathode, a first cathode current collector, and a first solid-state electrolyte positioned between the first anode and the first cathode; and the second electrode layer may comprise a second anode, a second anode current collector, a second cathode, a second cathode current collector, and a second solid-state electrolyte positioned between the second anode and the second cathode. In some aspects, the first positive tab may be coupled to the first cathode current collector and the first negative tab may be coupled to the first anode current collector; and the second positive tab may be coupled to the second cathode current collector and the second negative tab may be coupled to the second anode current collector. In some examples, the first positive tab and first negative tab may be offset from a central axis of the first electrode layer. In some examples, the second electrode layer may be a flipped version of the first electrode layer. In some aspects, the first electrode layer and the second electrode layer may be produced using one notching die configuration. In other aspects, the first positive tab and the first negative tab may axially protrude from the first electrode layer. In some aspects, the first positive tab and the first negative tab may form a first current path, and the second positive tab and the second negative tab may form a second current path.

In additional aspects, a solid-state pouch cell battery is provided that comprises: a first electrode layer comprising a first positive tab extending beyond an edge of the first electrode layer and a first negative tab extending beyond an opposing edge of the first electrode layer; and a second electrode layer comprising a second positive tab extending beyond an edge of the second electrode layer and a second negative tab extending beyond an opposing edge of the second electrode layer; where the second electrode layer is stacked on and aligned with a top surface of the first electrode layer; and where the second positive tab is misaligned with the first positive tab and the second negative tab is misaligned with the first negative tab. In some examples, the first electrode layer and the second electrode layer may each comprise double-side-coated electrodes. In some aspects, the first electrode layer may comprises a first anode, a first anode current collector, a first cathode, a first cathode current collector, and a first solid-state electrolyte positioned between the first anode and the first cathode; and wherein the second electrode layer comprises a second anode, a second anode current collector, a second cathode, a second cathode current collector, and a second solid-state electrolyte positioned between the second anode and the second cathode. In some examples, the first positive tab may be coupled to the first cathode current collector and the first negative tab may be coupled to the first anode current collector; and the second positive tab may be coupled to the second cathode current collector and the second negative tab may be coupled to the second anode current collector. In some examples, the first positive tab and first negative tab may be offset from a central axis of the first electrode layer.

In additional aspects, a method of manufacturing a solid-state pouch cell battery is provided that comprises: producing a first electrode layer comprising a first positive tab extending beyond an edge of the first electrode layer and a first negative tab extending beyond an opposing edge of the first electrode layer; producing a second electrode layer comprising a second positive tab extending beyond an edge of the second electrode layer and a second negative tab extending beyond an opposing edge of the second electrode layer; stacking the second electrode layer on a top surface of the first electrode layer, where the second electrode is substantially aligned with the first electrode layer; and where the second positive tab is misaligned with the first positive tab and the second negative tab is misaligned with the first negative tab. In some examples, the method may further comprise sealing the stacked first and second electrode layers in a pouch. In some examples, the first electrode layer and the second electrode layer may each comprise double-side-coated electrodes; and the first and second electrode layers may be produced using a single notching die configuration. In other examples, the first and second electrode layers may be produced using two different notching die configurations.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A battery comprising:
a first electrode layer comprising a first positive tab and a first negative tab; and
a second electrode layer comprising a second positive tab and a second negative tab, where the second electrode layer is stacked on top of the first electrode layer, where the second positive tab is misaligned with the first positive tab and the second negative tab is misaligned with the first negative tab.

2. The battery of claim 1, wherein the battery comprises a pouch cell battery.

3. The battery of claim 1, wherein the battery comprises a solid-state battery.

4. The battery of claim 1, wherein the first electrode layer and the second electrode layer each comprise double-side-coated electrodes.

5. The battery of claim 1, wherein the first electrode layer comprises a first anode, a first anode current collector, a first cathode, a first cathode current collector, and a first solid-state electrolyte positioned between the first anode and the first cathode; and wherein the second electrode layer comprises a second anode, a second anode current collector, a second cathode, a second cathode current collector, and a second solid-state electrolyte positioned between the second anode and the second cathode.

6. The battery of claim 5, wherein the first positive tab is coupled to the first cathode current collector and the first negative tab is coupled to the first anode current collector; and
wherein the second positive tab is coupled to the second cathode current collector and the second negative tab is coupled to the second anode current collector.

7. The battery of claim 1, wherein the first positive tab and first negative tab are offset from a central axis of the first electrode layer.

8. The battery of claim 1, wherein the second electrode layer is a flipped version of the first electrode layer.

9. The battery of claim 8, wherein the first electrode layer and the second electrode layer are produced using one notching die configuration.

10. The battery of claim 1, wherein the first positive tab and the first negative tab axially protrude from the first electrode layer.

11. The battery of claim 1, wherein the first positive tab and the first negative tab form a first current path, and wherein the second positive tab and the second negative tab form a second current path.

12. A solid-state pouch cell battery comprising:
a first electrode layer comprising a first positive tab extending beyond an edge of the first electrode layer and a first negative tab extending beyond an opposing edge of the first electrode layer; and
a second electrode layer comprising a second positive tab extending beyond an edge of the second electrode layer and a second negative tab extending beyond an opposing edge of the second electrode layer;
where the second electrode layer is stacked on and aligned with a top surface of the first electrode layer; and
where the second positive tab is misaligned with the first positive tab and the second negative tab is misaligned with the first negative tab.

13. The battery of claim 12, wherein the first electrode layer and the second electrode layer each comprise double-side-coated electrodes.

14. The battery of claim 12, wherein the first electrode layer comprises a first anode, a first anode current collector, a first cathode, a first cathode current collector, and a first solid-state electrolyte positioned between the first anode and the first cathode; and wherein the second electrode layer comprises a second anode, a second anode current collector, a second cathode, a second cathode current collector, and a second solid-state electrolyte positioned between the second anode and the second cathode.

15. The battery of claim 14, wherein the first positive tab is coupled to the first cathode current collector and the first negative tab is coupled to the first anode current collector; and
wherein the second positive tab is coupled to the second cathode current collector and the second negative tab is coupled to the second anode current collector.

16. The battery of claim 12, wherein the first positive tab and first negative tab are offset from a central axis of the first electrode layer.

17. A method of manufacturing a solid-state pouch cell battery comprising:
producing a first electrode layer comprising a first positive tab extending beyond an edge of the first electrode layer and a first negative tab extending beyond an opposing edge of the first electrode layer;
producing a second electrode layer comprising a second positive tab extending beyond an edge of the second electrode layer and a second negative tab extending beyond an opposing edge of the second electrode layer;
stacking the second electrode layer on a top surface of the first electrode layer, where the second electrode is substantially aligned with the first electrode layer; and where the second positive tab is misaligned with the first positive tab and the second negative tab is misaligned with the first negative tab.

18. The method of claim 17, further comprising sealing the stacked first and second electrode layers in a pouch.

19. The method of claim 17, wherein the first electrode layer and the second electrode layer each comprise double-side-coated electrodes; and wherein the first and second electrode layers are produced using a single notching die configuration.

20. The method of claim 17, wherein the first and second electrode layers are produced using two different notching die configurations.
